(19) United States
(12) Patent Application Publication
(10) Pub. No.: US 2004/0035417 A1
(43) Pub. Date: Feb. 26, 2004

(54) Medicament dispenser

(76) Inventor: David Michael Ottolangui, Ware (GB)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/399,158

(22) PCT Filed: Sep. 26, 2001
(86) PCT No.: PCT/EP01/11095

(30) Foreign Application Priority Data
Oct. 13, 2000 (GB) 0025092.8

(51) Int. Cl. A62B 7/00

(52) U.S. Cl. 128/202.17

(57) ABSTRACT

There is provided a dispenser for dispensing a medicament in a fluid propellant that includes a canister for housing the medicament and a drug-dispensing valve. The valve is made wholly or substantially of metal and the internal metal surfaces of the valve include a coating that enhances the surface energy thereof. The valve coating on the metal surfaces reduces the tendency of drug to adhere thereto, and improves the frictional properties thereof.

The present invention relates to metered dose inhalers. More especially, the invention relates to a metered dose inhaler for consistently dispensing a prescribed dose of medicament.

Drugs for treating respiratory and nasal disorders are frequently administered in aerosol formulations through the mouth or nose. One widely used method for dispensing such aerosol drug formulations involves formulating the drug as a suspension or a solution in a liquefied gas propellant. The suspension/solution is stored in a sealed canister capable of withstanding the pressure required to maintain the propellant as a liquid. The suspension/solution is dispersed by activation of a dose metering valve affixed to the canister.

A metering valve generally comprises a metering chamber which is of a set volume and is designed to administer per actuation an accurate predetermined dose of medicament. As the suspension/solution is forced from the canister through the dose metering valve by the high vapour pressure of the propellant, the propellant rapidly vaporizes leaving a fast moving cloud of very fine particles of the drug formulation. This cloud of particles is directed into the nose or mouth of the patient by a channeling device such as a cylinder or open-ended cone. Concurrently with the activation of the aerosol dose metering valve, the patient inhales the drug particles into the lungs or nasal cavity. Systems of dispensing drugs in this way are known as “metered dose inhalers” (MDI's). See Peter Byron, Respiratory Drug Delivery, CRC Press, Boca Raton, Fla. (1990) for a general background on this form of therapy.

Patients often rely on medication delivered by MDl's for rapid treatment of respiratory disorders which are debilitating and in some cases even life threatening. Therefore, it is essential that the prescribed doses of aerosol medication delivered to the patent consistently meet the specifications claimed by the manufacturer and comply with the requirements of the FDA and other regulatory authorities. That is, every dose in the can must be capable of delivery within the same close tolerances.

A problem which can exist with drug delivery devices such as MDI's is the deposition of the medicament, or the solid component from a suspension of a particulate product in a liquid propellant, onto the internal surfaces of the device which occurs after a number of operation cycles and/or storage. This can lead to a reduction in the efficacy of the device and of the resulting treatment as the deposition of the product reduces the amount of active drug available to be dispensed to the patient and markedly reduces the uniformity of the dose dispensed during the lifetime of the device.

The problem of drug adherence and dose uniformity can be greater with suspension formulations comprising hydrofluoroalkane propellants, for example, 1,1,1,2-tetrafluoroethane (HFA134a) and 1,1,1,2,3,3,3-n-heptafluoropropane (HFA227) which have been developed as ozone friendly replacements of chlorofluorocarbons such as P11, P114 and P12.

Some prior art devices rely on the dispenser being shaken so as to agitate the liquid propellant and product mixture therein, in an attempt to dislodge the deposited particles. However, while in some cases this remedy can be effective within the body of the drug container itself, it may not be effective for particles deposited on the inner surfaces of other MDI components such as the metering valve.

The Applicants have found that the aforementioned problem of drug adherence and dose uniformity can be greater when the metering valve is substantially comprised of a metal, such as stainless steel. Unexpectedly, the Applicants have found that by providing a coating material to the metal parts of the metering valve to enhance the surface energy thereof the problem is ameliorated. Drug deposition is thereby reduced resulting in greater dose uniformity over the lifetime of the device.

Canadian patent application 2130867 describes a metered dose inhaler containing an aerosol formulation in which the internal walls of the metal canister are coated with a cross-linked plastics coating. Polytetrafluoroethylene (PTFE) and perfluoroethylenepropylene (FEP) are specifically mentioned as suitable coating materials

UK patent application GB-A-2,328,932 discloses the use of a liner of a material such as fluoropolymer, ceramic or glass to line a portion of the wall of the metering chamber in a metering valve of an MDI. Although this alleviates the problem of deposition in these types of dispensers, it does require the re-design or modification of mouldings and mould tools for producing the valve members to allow for insertion of the liner.

According to one aspect of the present invention there is provided a dispenser for dispensing a medicament in a fluid propellant comprising (a) a canister for housing the medicament; and (b) a drug-dispensing valve made wholly or substantially of metal, wherein the internal metal surfaces of said valve comprise a coating which enhances the surface energy thereof.

Suitably, the valve is a metering valve.

The valve is made wholly or substantially of metal. In one aspect, all of the internal surfaces of the valve are made of metal. In another aspect, all parts of the valve other than any sealing rings thereof are made wholly of metal.

In one aspect, the valve is made substantially of metal and the remainder of the valve is comprised of a non-metal.

Suitable metals for use in the valve include stainless steel, aluminum, copper, tin plate and any alloys thereof.

Suitable non-metals for use in the valve include pharmacologically resilient polymers such as acetal, polyamide (e.g. Nylon®), polycarbonate, polyester, fluorocarbon polymer (e.g. Teflon®) or a combination of these materials. Additionally, seals and “O” rings of various materials (e.g., nitrile rubbers, polyurethane, acetyl resin, fluorocarbon polymers), or other elastomeric materials are employed in and around the valve. Preferably, the valve, other than sealing rings, is made of metal.

The valve can have any suitable configuration. Metal and non-metal parts can be combined to optimise the performance of the valve.

Any metal parts of the valve which contact the pharmaceutical aerosol suspension may be coated with materials to reduce the surface energy thereof. The reduced surface energy acts such as to reduce the tendency of medicament to deposit or precipitate out thereon. Where the valve part is a movable part (e.g. the valve stem) the reduced surface energy also reduces the friction between that part and another part of the valve (e.g. the stem seal).

In one aspect herein, the valve stem is coated to reduce its frictional contact properties and the need for any further stem lubricant such as silicone oil is reduced or eliminated. Reducing frictional contact can be particularly advantageous where the valve is employed in a dispenser for both suspension and solution medicament formulations.

Suitably, the surface energy is modified to give a contact angle of greater than 70 degrees, preferably greater than 90 degrees, more preferably greater than 110 degrees.

As used herein, “contact angle” is identified as the angle between a liquid water droplet and a solid surface of the valve at the liquid/solid interface.

Any movable parts (e.g. the valve stem in a slide valve) of the valve may also have coatings applied thereto which enhance their desired movement characteristics. Frictional coatings may therefore be applied to enhance frictional contact and lubricants used to reduce frictional contact as necessary.

Suitable coating materials comprise polymeric compounds. Polymeric coatings may be employed as mixtures, the nature of which may be varied as part of optimisation of the employment of the invention.

Preferred coating materials comprise fluorine such as fluorine-containing polymers as fluoropolymers and copolymers of fluoropolymers with other polymeric materials.

Preferably, the fluorine-containing polymer is highly fluorinated, e.g. has a high fluorine to carbon ratio.

Suitable fluoropolymers include polytetrafluoroethylene (PTFE), ethylenetetrafluoroethylene (ETFE), polyvinyldienefluoride (PVDF), perfluoroalkoxyalkane (PFA), polyvinylfluoride (PVF), polychlorotrifluoroethylene (PCTFE) and fluorinated ethylenepropylene (FEP). Fluorocarbon polymers are marketed under trademarks such as Teflon®, Tefzel®, Halar® and Hostaflon®, Polyflon® and Neoflon®. Grades of polymer include FEP DuPont 856-200, PFA DuPont 857-200, PTFE-PES DuPont 3200-100, PTFE-FEP-polyamideimide DuPont 856P23485, FEP powder DuPont 532, and PFA Hoechst 6900n.

Suitable copolymers comprise from 1 to 99%, preferably from 5 to 95% by weight of fluorinated polymer. Suitable copolymers include copolymers of tetrafluoroethylene (TFE) with PFA, TFE with hexafluoropropylene (HFP) (available as FEP 6107 and FEP 100 from DYNEON), VDF with HFP (commercially available as Viton A), TFE with perfluoro(propyl vinyl ether) (available as PFA 6515N from DYNEON), a blend of TFE, hexafluoropropylene and vinylidene fluoride (available commercially as THV 200G from DYNEON), HOSTAFORM X329™ (Hoechst) which is a 5% PTFE/Acetal blend, HOSTAFORM C9021TF which is a 20% PTFE/Acetal blend, PTFE/PBT blends (for example, LNP WL4040), and PTFE/PBT/silicone blends (for example, LNP WL4540).

Other suitable coatings comprise cross-linked fluorinated polymers. In one aspect, the treated surface has one or more fluorocarbon polymers in combination with one or more non-fluorocarbon polymers disposed thereon. In another aspect, the treated surface has a linear, non-cross-linked polymeric compound disposed thereon.

In one aspect, the coating compound comprises a functional grouping which is capable of anchoring the compound to the surface thereof. As a first example, the compound may be an organo-phosphate such as a phosphate based perfluoroether derivative. As a second example, the compound may be an organo-silane derivative such as a silane derivative of perfluoropolyoxyalkane e.g. a silane derivative of perfluoropolyoxyalkane having a molecular weight-in the range 1600-1750.

Typically, the compound is a phosphoric ester.

In one embodiment, the coating compound comprises the general formula:

R¹—(CH₂)ᵥ—CF₂O—(C₂F₄O)ₓ—(CF₂O)_{y}CF₂—(CH₂)_{w}—R¹ (1)

wherein R¹ comprises:

—(OCH₂—CH₂)_{Z}—OPO(OH)₂, wherein x, y and z are such that the molecular weight of the compound is 900-2100 and v and w independently represent 1 or 2.

In one preferred embodiment, v and w are both 1. In a second preferred embodiment v and w are both 2.

Compounds of formula (I) will generally be employed as mixtures, the nature of which may be varied as part of optimisation of the employment of the invention.

The synthesis of compounds of formula (I) may readily be determined by reference to EP0 687 533 which describes similar compounds.

In another embodiment, the coating compound has the general formula:

R¹—(OC₃F₆)ₓ—(OCF₂)_{y}—R² (II)

Wherein R¹ comprises a fluoro-alkyl functional group;

x and y are such that the molecular weight of the compound is 350-1000; and

R² comprises a phosphoric ester functional group

Whilst not wishing to be bound by any theory, it is believed that the anchoring (e.g phosphate) moiety of the compounds of formulas (I) and (II) reacts with the surface of the component to anchor the compound to the surface. Thus, when in use, the per-fluorinated end of the compound is presented to the pharmaceutical formulation and so provides a highly fluorinated surface. Further embodiments include perfluoropolyethers having functional groups of the type —CONR²R³ wherein R² and R³ may be independently selected from hydrogen, or a silyl ether ether (e.g. SiRₜ(OR)₃₋ₜ wherein R=hydrogen or C₁₋₈ alkyl and t=0 to 2) as disclosed in U.S. Pat. No. 4,746,550 which is incorporated herein by reference. Methods of preparing polymeric compounds of the type described above may readily be determined by reference to the aforementioned US patent.

Other suitable coatings include siloxanes such as dimethyl siloxane which in one aspect, may be applied by plasma polymerisation processes.

Fluorine-containing polymers may be blended with non-fluorinated polymers such as polyamides, polyimides, polyethersulfones, polyphenylene sulfides, and amine-formaldehyde thermosetting resins to give blended coatings. These added polymers improve adhesion of the polymer coating to the valve. Preferred polymer blends are PTFE/FEP/polyamideimide, PTFE/polyether sulphone (PES) and FEP-benzoguanamine.

Particularly preferred coatings are blends of PTFE and polyethersulphone (PES).

The valve may be coated by any means known in the art of metal coating. For example, metal parts may be precoated as coil stock and cured before being stamped or drawn into the valve shape.

Other suitable coating techniques include electrostatic dry powder coating or by spraying preformed valves inside with formulations of the coating with optional curing. The valve may also be dipped in the coating formulation and cured, thus becoming coated on the inside and out. The coating formulation may also be poured inside the valve then drained out leaving the insides coated. The coating may also be formed in situ at the valve using plasma polymerization as described below.

Coating and optional curing conditions may be varied to suit the particular coating type. For coil coating and spray coating temperatures in excess of the melting point of the polymer are typically required, for example, about 50° C. above the melting point for up to about 20 minutes such as about 5 to 10 minutes eg about 8 minutes or as required. For the above named preferred and particularly preferred polymer blends curing temperatures in the range of about 300° C. to about 400° C., e.g. about 350° C. to 380° C. are suitable.

One suitable means of applying a fluorine-containing coating is by plasma coating, for example, by a CF4 or fluorine ion plasma coating technique. The plasma coating may consist of a fluorinated polymer laid down on the surface of the valve component, preferably the chamber, by polymerisation or by modification of a hydrocarbon-containing pre-coating on the surface by interchange of hydrogen ions in the material with fluorine ions. The coating process typically takes place in a vacuum at ambient temperature. The components to be coated are placed inside a chamber which is evacuated. The fluorine monomer or fluorine source is introduced into the chamber at a controlled rate. The plasma is ignited within the chamber and maintained for a given time at a chosen power setting. For plasma polymerization typically temperatures in the range of about 20° C. to about 100° C. may be employed. At the end of the treatment the plasma is extinguished, the chamber flushed and the products retrieved. In the polymerisation process, a thin layer of plasma polymer will be bonded to the valve.

The coating thickness is in the range of about 1 μm to about 1 mm. Suitably the coating thickness is in the range of about 1 μm to about 100 μm, e.g. 1 μm to 25 μm. Coatings may be applied in one or more coats.

The term “metered dose inhaler” or “MDI” means a unit comprising a canister, a crimped cap covering the mouth of the canister, a drug metering valve situated in the cap, a metering chamber and a suitable channeling device into which the canister is fitted. The term “drug metering valve” or “MDI valve” refers to a valve and its associated mechanisms which delivers a predetermined amount of drug formulation from an MDI upon each activation. The channeling device may comprise, for example, an actuating device for the valve and a cylindrical or cone-like passage through which medicament may be delivered from the filled MDI can via the MDI valve to the nose or mouth of a patient, e.g. a mouthpiece actuator. The relation of the parts of a typical MDI is illustrated in U.S. Pat. No. 5,261,538.

Preferably, the canister and/or the valve are made of stainless steel or aluminium. The advantages of incorporating a metal drug metering valve and canister include the ability to exert tighter control on component tolerances during manufacture. In addition, studies have found that a conducting component surface that is treated to have a defined surface energy facilitates dose uniformity. Therefore, if the canister and the valve are substantially made of metal or metal alloys, almost the entire MDI can be conducting and contribute towards the maintenance of a consistent dose.

Optionally, a moisture absorbing means may be comprised within the dispenser herein as a component thereof. Alternatively, the moisture absorbing means may be a separate component of the formulation contained within the dispenser.

The moisture absorbing means may comprise a component or accessory for use with a canister or valve that is made from a plastics material which is a natural desiccant, such as a polyamide, for example nylon, or may be moulded from other plastics material such as Acetal or PBT and include a desiccant such as a molecular sieve and silica gel. Alternatively, or in addition, the moisture absorbing means may comprise an internal lining or coating. In one embodiment, the moisture absorbing means may be incorporated into a treatment or coating for canisters and/or valves for preventing drug deposition and/or maintaining dose uniformity.

Other vapour or moisture absorbing materials include desiccants made from inorganic materials such zeolites and aluminas. Such inorganic materials have high water absorption capacities and favorable water absorption isotherm shapes. The water absorption capacity of such materials typically varies from 20 to 50 weight percent.

Other exemplary moisture absorbing materials include, but are not limited to, alumina, bauxite, anhydrous, calcium sulfate, water-absorbing clay, activated bentonite clay, a molecular sieve, or other like materials.

In conjunction with the desiccant an additional compound may be added to act as a conduit/channeling agent to increase/optimize the efficiency of the moisture absorption properties. Such materials may include compounds such as polyethylene glycols.

Preferably, the means for absorbing moisture reduces the rise in moisture content over time, and/or the decrease in Fine Particulate Mass over time by between 20 and 100%, for example, 40 to 70%, e.g. 45 to 55%.

Typically, the component or accessory takes the form of a cap and/or a seal and/or a lining.

The desiccant should be present in an amount sufficient to absorb any increases in moisture around the valve area of the MDI and thus alleviate or substantially prevent moisture increases inside the canister.

Typically, 100 μg to 5 g, for example, 1 mg to 1 g, e.g. 100 mg to 500 mg, such as about 100 mg to 250 mg of desiccant may be included.

Typically, the propellant includes a hydrofluoroalkane, for example, at least one of 1,1,1,2-tetrafluoroethane (HFA-134a) and 1,1,1,2,3,3,3-heptafluoropropane (HFA227). 1,1,1,2-tetrafluoroethane (HFA-134a) is a preferred propellant herein.

In another aspect, the invention provides a drug-dispensing valve for use in a dispenser for dispensing a medicament in a fluid propellant, the valve made wholly or substantially of metal, wherein the internal metal surfaces of said valve comprise a coating which enhances the surface energy thereof.

Typically, the drug-dispensing valve is a metering valve.

In another aspect, the invention provides a metered dose inhaler for dispensing a medicament in a fluid propellant comprising a dispenser as defined above and a medicament channeling device, such as an actuator.

The canister herein optionally comprises moisture absorbing means which takes the form of a crimped cap, and/or coating, and/or treatment, and/or lining, and/or other accessory for sealing the canister. The moisture absorbing means may be made of a material which is naturally a desiccant or a plastics material including a desiccant.

Typically, the canister contains a pharmaceutical aerosol formulation comprising a medicament and a fluorocarbon propellant.

In still another aspect, the invention provides a method of preventing drug deposition in a dispenser for dispensing a medicament in a fluid propellant having a canister for housing the medicament and a drug-dispensing valve, the method comprising the use of a dispenser or a drug metering valve as defined above.

The metered dose inhalers may be prepared by methods of the art (e.g. see Byron above and U.S. Pat. No. 5,345,980).

Conventionally, the canisters and caps for use in MDI's are made of aluminium or an alloy of aluminium although other metals not affected by the drug formulation, such as stainless steel, an alloy of copper, or tin plate, may be used. An MDI canister may also be fabricated from glass or plastics. Preferably, however, the MDI canisters and caps employed in the present invention are made of aluminium or an alloy thereof.

The canister and any caps or channeling devices herein may be coated with any of the coatings described herein for use as valve coatings.

The canister is preferably a pressurized container comprising an aluminum metal vial having a metering valve disposed therein. While the pressurized container preferably includes a metering valve, other valve systems are not beyond the scope of the present invention. Other valve systems include, but are not limited to, wedge gate valve systems, double-disc gate valve systems, globe and angle valve systems, swing check valve systems, end cock valve systems, and other like valve systems. Since the pressurized container is preferably part of an MDI, the valve design is typically a function of providing a predetermined dosage or amount of the drug contained within the pressurized container to a user.

The valve typically comprises a valve body having an inlet port through which the pharmaceutical aerosol formulation may enter said valve body, an outlet port through which the pharmaceutical aerosol may exit the valve body and an open/close mechanism by means of which flow through said outlet port is controllable.

The valve may be a slide valve wherein the open/close mechanism comprises a sealing ring and receivable by the sealing ring a valve stem having a dispensing passage, the valve stem being slidably movable within the ring from a valve-closed to a valve-open position in which the interior of the valve body is in communication with the exterior of the valve body via the dispensing passage.

Typically, the valve is a metering valve. The metering volumes are typically from 50 to 100 μl, such as 50 μl or 63 μl. Suitably, the valve body defines a metering chamber for metering an amount of medicament formulation and an open/close mechanism by means of which the flow through the inlet port to the metering chamber is controllable. Preferably, the valve body has a sampling chamber in communication with the metering chamber via a second inlet port, said inlet port being controllable by means of an open/close mechanism thereby regulating the flow of medicament formulation into the metering chamber.

The valve may be a metering valve in which the valve body has a metering chamber, a sampling chamber and therebetween a second sealing ring within which the stem is slidably movable, the valve stem having a transfer passage such that in the valve-closed position the dispensing passage is isolated from the metering chamber and the metering chamber is in communication with the sampling chamber via the transfer passage, and in the valve-open position the dispensing passage is in communication with the metering chamber and the transfer passage is isolated from the metering chamber.

The valve may also comprise a ‘free flow aerosol valve’ having a chamber and a valve stem extending into the chamber and movable relative to the chamber between dispensing and non-dispensing positions. The valve stem has a configuration and the chamber has an internal configuration such that a metered volume is defined therebetween and such that during movement between is non-dispensing and dispensing positions the valve stem sequentially: (i) allows free flow of aerosol formulation into the chamber, (ii) defines a closed metered volume for pressurized aerosol formulation between the external surface of the valve stem and internal surface of the chamber, and (iii) moves with the closed metered volume within the chamber without decreasing the volume of the closed metered volume until the metered volume communicates with an outlet passage thereby allowing dispensing of the metered volume of pressurized aerosol formulation. A valve of this type is described in U.S. Pat. No. 5,772,085.

The valve may also have a structure and action similar to those aerosol valves described in European Patent Application No. EP-A-870,699 and PCT Patent Application No. WO99/36334.

The sealing ring may be formed by cutting a ring from a sheet of suitable material. Alternatively, the sealing ring may be formed by a moulding process such as an injection moulding, a compression moulding or a transfer moulding process.

Typically, the sealing ring and/or second sealing ring comprise an elastomeric material. The ring is typically resiliently deformable.

The elastomeric material may either comprise a thermoplastic elastomer (TPE) or a thermoset elastomer which may optionally be cross-linked. The sealing ring may also comprise a thermoplastic elastomer blend or alloy in which an elastomeric material is dispersed in a thermoplastic matrix. The elastomers may optionally additionally contain conventional polymer additives such as processing aids, colorants, tackifiers, lubricants, silica, talc, or processing oils such as mineral oil in suitable amounts.

Suitable thermoset rubbers include butyl rubbers, chloro-butyl rubbers, bromo-butyl rubbers, nitrile rubbers, silicone rubbers, flurosilicone rubbers, fluorocarbon rubbers, polysulphide rubbers, polypropylene oxide rubbers, isoprene rubbers, isoprene-isobutene rubbers, isobutylene rubbers or neoprene (polychloroprene) rubbers.

Suitable thermoplastic elastomers comprise a copolymer of about 80 to about 95 mole percent ethylene and a total of about 5 to about 20 mole percent of one or more comonomers selected from the group consisting of 1-butene, 1-hexene, and 1-octene as known in the art. Two or more such copolymers may be blended together to form a thermoplastic polymer blend.

Another suitable class of thermoplastic elastomers are the styrene-ethylene/butylene-styrene block copolymers. These copolymers may additionally comprise a polyolefin (e.g. polypropylene) and a siloxane.

Thermoplastic elastomeric material may also be selected from one or more of the following: polyester rubbers, polyurethane rubbers, ethylene vinyl acetate rubber, styrene butadiene rubber, copolyether ester TPE, olefinic TPE, polyester amide TPE and polyether amide TPE.

Other suitable elastomers include ethylene propylene diene rubber (EPDM). The EPDM may be present on its own or present as part of a thermoplastic elastomer blend or alloy, e.g. in the form of particles substantially uniformly dispersed in a continuous thermoplastic matrix (e.g. polypropylene or polyethylene). Commercially available thermoplastic elastomer blend and alloys include the SANTOPRENE™ elastomers. Other suitable thermoplastic elastomer blends include butyl-polyethylene (e.g. in a ratio ranging between about 2:3 and about 3:2) and butyl-polypropylene.

Typically, the sealing ring and/or the second sealing ring additionally comprises lubricant material. Suitably, the sealing ring and/or the second sealing ring comprises up to 30%, preferably from 5 to 20% lubricant material.

In addition, the stem may also comprise lubricant material. Suitably, the valve stem comprises up to 30%, preferably from 5 to 20% lubricant material.

The term ‘lubricant’ herein means any material which reduces friction between the valve stem and seal. Suitable lubricants include silicone oil or a fluorocarbon polymer such as polytetrafluoroethane (PTFE) or fluoroethylene propylene (FEP).

Lubricant can be applied to the stem, sealing ring or a second sealing ring by any suitable process including coating and impregnation, such as by injection or a tamponage process.

In medical use the canisters in accordance with the invention contain a pharmaceutical aerosol formulation comprising a medicament and a fluorocarbon or hydrogen-containing chlorofluorocarbon propellant.

Suitable propellants include, for example, C₁₋₄hydrogen-containing chlorofluorocarbons such as CH₂ClF, CClF₂CHClF, CF₃CHClF, CHF₂CClF₂, CHClFCHF₂, CF₃CH₂Cl and CClF₂CH₃; C₁₋₄hydrogen-containing fluorocarbons such as CHF₂CHF₂, CF₃CH₂F, CHF₂CH₃ and CF₃CHFCF₃; and perfluorocarbons such as CF₃CF₃ and CF₃CF₂CF₃.

Where mixtures of the fluorocarbons or hydrogen-containing chlorofluorocarbons are employed they may be mixtures of the above identified compounds or mixtures, preferably binary mixtures, with other fluorocarbons or hydrogen-containing chlorofluorocarbons for example CHClF₂, CH₂F₂ and CF₃CH₃. Preferably a single fluorocarbon or hydrogen-containing chlorofluorocarbon is employed as the propellant. Particularly preferred as propellants are C₁₋₄hydrogen-containing fluorocarbons such as 1,1,1,2-tetrafluoroethane (CF₃CH₂F) and 1,1,1,2,3,3,3-heptafluoro-n-propane (CF₃CHFCF₃) or mixtures thereof.

The pharmaceutical formulations for use in the canisters of the invention contain no components which provoke the degradation of stratospheric ozone. In particular the formulations are substantially free of chlorofluorocarbons such as CCl₃F, CCl₂F₂ and CF₃CCl₃.

The propellant may additionally contain a volatile adjuvant such as a saturated hydrocarbon for example propane, n-butane, isobutane, pentane and isopentane or a dialkyl ether for example dimethyl ether. In general, up to 50% w/w of the propellant may comprise a volatile hydrocarbon, for example 1 to 30% w/w. However, formulations which are free or substantially free of volatile adjuvants are preferred. In certain cases, it may be desirable to include appropriate amounts of water, which can be advantageous in modifying the dielectric properties of the propellant.

The invention is particularly useful with propellants (including propellant mixtures) which are more hygroscopic than P11, P114 and/or P12 such as HFA-134a and HFA-227.

A polar co-solvent such as C₂₋₆ aliphatic alcohols and polyols e.g. ethanol, isopropanol and propylene glycol, preferably ethanol, may be included in the drug formulation in the desired amount to improve the dispersion of the formulation, either as the only excipient or in addition to other excipients such as surfactants. Suitably, the drug formulation may contain 0.01 to 5% w/w based on the propellant of a polar co-solvent e.g. ethanol, preferably 0.1 to 5% w/w e.g. about 0.1 to 1% w/w. In aspects herein, the solvent is added in sufficient quantities to solubilise the part or all of the medicament component, such formulations being commonly referred to as solution formulations.

A surfactant may also be employed in the aerosol formulation. Examples of conventional surfactants are disclosed in EP-A-372,777. The amount of surfactant employed is desirable in the range 0.0001% to 50% weight to weight ratio relative to the medicament, in particular, 0.05 to 5% weight to weight ratio. Preferred surfactants are lecithin, oleic acid and sorbitan trioleate. Preferred formulations, however, are free or substantially free of surfactant.

Pharmaceutical formulations may contain 0.0001 to 50% w/w, preferably 0.001 to 20%, for example 0.001 to 1% of sugar relative to the total weight of the formulation. Generally the ratio of medicament to sugar falls within the range of 1:0.01 to 1:100 preferably 1:0.1 to 1:10. Typical sugars which may be used in the formulations include, for example, sucrose, lactose and dextrose, preferably lactose, and reducing sugars such as mannitol and sorbitol, and may be in micronised or milled form.

The final aerosol formulation desirably contains 0.005-10% w/w, preferably 0.005 to 5% w/w, especially 0.01 to 1.0% w/w, of medicament relative to the total weight of the formulation.

Medicaments which may be administered in the aerosol formulations include any drug useful in inhalation therapy. The dispenser of the invention is in one aspect suitable for dispensing medicament for the treatment of respiratory disorders such as disorders of the lungs and bronchial tracts including asthma and chronic obstructive pulmonary disorder (COPD).

Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (eg s the sodium salt), ketotifen or nedocromil (eg as the sodium salt); antinfectives e.g., cephalosporins, peniciflins, streptomycin, sulphonamides, tetracyclines and pentamidine; antihistamines, e.g., methapyrilene; anti-inflammatories, e.g., beclomethasone (eg as the dipropionate ester), fluticasone (eg as the propionate ester), flunisolide, budesonide, rofleponide, mometasone eg as the furoate ester), ciclesonide, triamcinolone (eg as the acetonide) or 6α,9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., albuterol (eg as free base or sulphate), salmeterol (eg as xinafoate), ephedrine, adrenaline, fenoterol (eg as hydrobromide), formoterol (eg as fumarate), isoprenaline, metaproterenol, phenylephrine, phenylpropanolamine, pirbuterol (eg as acetate), reproterol (eg as hydrochloride), rimiterol, terbutaline (eg as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; adenosine 2a agonists, eg 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g. as maleate); α₄ integrin inhibitors eg (2S)-3-[4-({[4-(aminocarbonyl)-1-piperidinyl]carbonyl}oxy)phenyl]-2-[((2S)-4-methyl-2-{[2-(2-methylphenoxy) acetyl]amino}pentanoyl)amino] propanoic acid (e.g as free acid or potassium salt), diuretics, e.g., amiloride; anticholinergics, e.g., ipratropium (eg as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagon; vaccines, diagnostics, and gene therapies. It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament.

Preferred medicaments are selected from albuterol, salmeterol, fluticasone propionate and beclomethasone dipropionate and salts or solvates thereof, e.g., the sulphate of albuterol and the xinafoate of salmeterol.

Medicaments can also be delivered in combinations. Preferred formulations containing combinations of active ingredients contain salbutamol (e.g., as the free base or the sulphate salt) or salmeterol (e.g., as the xinafoate salt) or formoterol (eg as the fumarate salt) in combination with an antiinflammatory steroid such as a beclomethasone ester (e.g., the dipropionate) or a fluticasone ester (e.g., the propionate) or budesonide. A particularly preferred combination is a combination of fluticasone propionate and salmeterol, or a salt thereof (particularly the xinafoate salt). A further combination of particular interest is budesonide and formoterol (e.g. as the fumarate salt).

Particularly preferred formulations for use in the canisters of the present invention comprise a medicament and a C₁₋₄ hydrofluoroalkane particularly 1,1,1,2-tetrafluoroethane and 1,1,1,2,3,3,3-n-heptafluoropropane or a mixture thereof as propellant.

Preferred formulations are free or substantially free of formulation excipients. Thus, preferred formulations consist essentially of (or consist of) the medicament and the selected propellant.

Conventional bulk manufacturing methods and machinery well known to those skilled in the art of pharmaceutical aerosol manufacture may be employed for the preparation of large scale batches for the commercial production of filled canisters. Thus, for example, in one bulk manufacturing method a metering valve is crimped onto an aluminium can to form an empty canister. The particulate medicament is added to a charge vessel and liquified propellant is pressure filled through the charge vessel into a manufacturing vessel. The drug suspension is mixed before re-circulation to a filling machine and an aliquot of the drug suspension is then filled through the metering valve into the canister. Typically, in batches prepared for pharmaceutical use, each filled canister is check-weighed, coded with a batch number and packed into a tray for storage before release testing.

Each filled canister is conveniently fitted into a suitable channeling device prior to use to form a metered dose inhaler for administration of the medicament into the lungs or nasal cavity of a patient. Suitable channeling devices comprise for example a valve actuator and a cylindrical or cone-like passage through which medicament may be delivered from the filled canister via the metering valve to the nose or mouth of a patient e.g. a mouthpiece actuator. Metered dose inhalers are designed to deliver a fixed unit dosage of medicament per actuation or “puff”, for example in the range of 10 to 5000 microgram medicament per puff.

Administration of medicament may be indicated for the treatment of mild, moderate or severe acute or chronic symptoms or for prophylactic treatment. It will be appreciated that the precise dose administered will depend on the age and condition of the patient, the particular particulate medicament used and the frequency of administration and will ultimately be at the discretion of the attendant physician. When combinations of medicaments are employed the dose of each component of the combination will in general be that employed for each component when used alone. Typically, administration may be one or more times, for example from 1 to 8 times per day, giving for example 1, 2, 3 or 4 puffs each time. Each valve actuation, for example, may deliver 5 μg, 50 μg, 100 μg, 200 μg or 250 μg of a medicament. Typically, each filled canister for use in a metered dose inhaler contains 60, 100, 120 or 200 metered doses or puffs of medicament; the dosage of each medicament is either known or readily ascertainable by those skilled in the art.

A still further aspect of the present invention comprises a method of treating respiratory disorders such as, for example, asthma, which comprises administration by inhalation of an effective amount of an aerosol formulation as herein described from a dispenser of the present invention.

Embodiments of the invention will now be described with reference to the accompanying drawings in which:

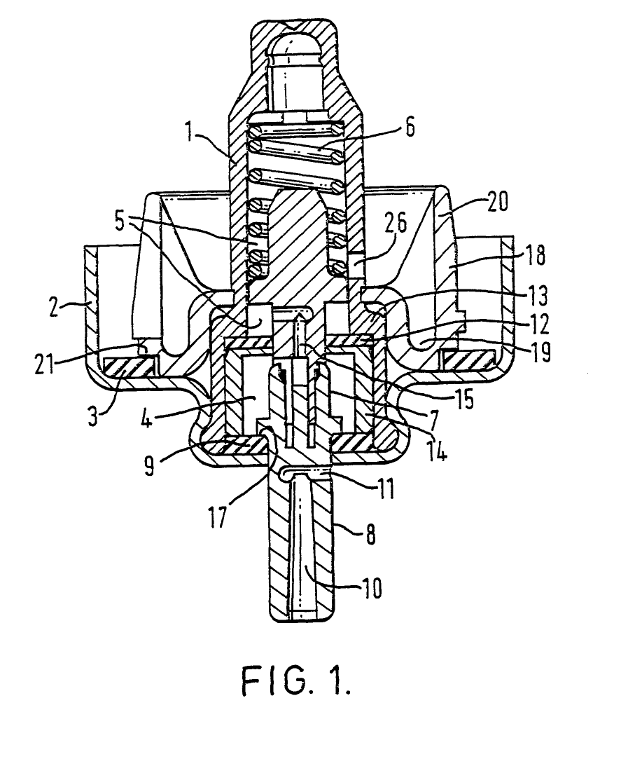

FIG. 1. is a schematic representation of a valve herein.

A valve according to the invention is shown in FIG. 1 and comprises a valve body 1 sealed in a ferrule 2 by means of crimping, the ferrule itself being set on the neck of a container (not shown) with interposition of a gasket 3 in a well-known manner.

The valve body 1 is formed at its lower part with a metering chamber 4, and it upper part with a sampling chamber 5 which also acts as a housing for a return spring 6. The words “upper” and “lower” are used for the container when it is in a use orientation with the neck of the container and valve at the lower end of the container which corresponds to the orientation of the valve as shown in FIG. 1. Inside the valve body 1 is disposed a valve stem 7, a part 8 of which extends outside the valve through lower stem seal 9 and ferrule 2. The stem part 8 is formed with an inner axial or longitudinal canal 10 opening at the outer end of the stem and in communication with a radial passage 11.

The upper portion of stem 7 has a diameter such that it can slide through an opening in an upper stem seal 12 and will engage the periphery of that opening sufficiently to provide a seal. Upper stem seal 12 is held in position against a step 13 formed in the valve body 1 between the said lower and upper parts by a sleeve 14 which defines the metering chamber 4 between lower stem seal 9 and upper stem seal 12. The valve stem 7 has a passage 15 which, when the stem is in the inoperative position shown, provides a communication between the metering chamber 4 and sampling chamber 5, which itself communicates with the interior of the container via orifice 26 formed in the side of the valve body 1.

Valve stem 7 is biased downwardly to the inoperative position by return spring 6 and is provided with a shoulder 17 which abuts against lower stem seal 9. In the inoperative position as shown in FIG. 1 shoulder 17 abuts against lower stem seal 9 and radial passage 11 opens below lower stem seal 9 so that the metering chamber 4 is isolated from canal 10 and suspension inside cannot escape.

A ring 18 having a “U” shaped cross section extending in a radial direction is disposed around the valve body below orifice 26 so as to form a trough 19 around the valve body. As seen in FIG. 1 the ring is formed as a separate component having an inner annular contacting rim of a diameter suitable to provide a friction fit over the upper part of valve body 1, the ring seating against step 13 below the orifice 26. However, the ring 18 may alternatively be formed as an integrally moulded part of valve body 1.

To use the device the container is first shaken to homogenise the suspension within the container. The user then depresses the valve stem 7 against the force of the spring 6. When the valve stem is depressed both ends of the passage 15 come to lie on the side of upper stem seal 12 remote from the metering chamber 4. Continued depression of the valve stem will move the radial passage 11 into the metering chamber 4 while the upper stem seal 12 seals against the valve stem body. Thus, the metered dose can exit through the radial passage 11 and the outlet canal 10.

In accord with the present invention, all parts of the valve with the exception of the upper and lower stem seals 9 and 12 are comprised of stainless steel. The internal surfaces of the valve are coated with a layer of fluorocarbon comprising PTFE. In another aspect, the coating is a blend of PTFE and PES. In alternatives, the ring 18 is comprised of a plastic material such as nylon, optionally coated with a fluoropolymer.

Releasing the valve stem causes it to return to the illustrated position under the force of the spring 6. The passage 15 then once again provides communication between the metering chamber 4 and sampling chamber 6. Accordingly, at this stage liquid passes under pressure from the container through orifice 26, through the passage and thence into the metering chamber 4 to fill it.

It will be understood that the present disclosure is for the purpose of illustration only and the invention extends to modifications, variations and improvements thereto which will be within the ordinary skill of the person skilled in the art.

1. A dispenser for dispensing a medicament in a fluid propellant comprising
(a) a canister for housing the medicament; and
(b) a drug-dispensing valve made wholly or substantially of metal, wherein the internal metal surfaces of said valve comprise a coating which enhances the surface energy thereof.

2. A dispenser as claimed in claim 1 wherein the valve is a metering valve.

3. A dispenser as claimed in any one of claims 1 to 3 wherein the valve comprises a metal selected from the group consisting of stainless steel, aluminium, copper, tin and any alloys thereof.

4. A dispenser as claimed in any one of claims 1 to 3, wherein the valve is made wholly of metal.

5. A dispenser as claimed in any one of claims 1 to 4, wherein the internal metal surfaces of the valve have a surface energy defined by a contact angle of greater than 70 degrees.

6. A dispenser as claimed in any one of claims 1 to 5, wherein said coating comprises a polymeric material.

7. A dispenser as claimed in claim 6, wherein said polymeric material is selected from the group consisting of a fluoropolymer, and a copolymer of a fluoropolymer with another polymer.

8. A dispenser as claimed in claim 7, wherein the fluoropolymer is selected from the group consisting of polytetrafluoroethylene (PTFE), ethylenetetrafluoroethylene (ETFE), polyvinyldienefluoride (PVDF), perfluoroalkoxyalkane (PFA), polyvinylfluoride (PVF), polychlorotrifluoroethylene (PCTFE) and fluorinated ethylenepropylene (FEP).

9. A dispenser as claimed in either of claims 7 or 8, wherein the coating comprises a blend of fluoropolymer and a blend material selected from the group consisting of polyamides, polyimides, polyethersulphones, polyphenylene sulphides, and amine-formaldehyde thermosetting resins.

10. A dispenser as claimed in any of claims 1 to 6, wherein the coating comprises a phosphate based perfluoroether derivative.

11. A dispenser as claimed in any of claims 1 to 6, wherein the coating comprises a silane derivative of perfluoropolyoxyalkane.

12. A dispenser as claimed in any of claims 1 to 6, wherein the coating comprises a siloxane polymer.

13. A dispenser as claimed in any one of the preceding claims comprising a medicament in a fluid propellant, wherein the fluid propellant includes a hydrofluoroalkane.

14. A dispenser as claimed in claim 13, wherein the hydrofluoroalkane is selected from the group consisting of 1,1,1,2-tetrafluoroethane, 1,1,1,2,3,3,3-heptafluoropropane; and any mixtures thereof.

15. A dispenser as claimed in either of claims 13 or 14, additionally comprising solvent at a level of 0.01% to 5% w/w of the fluid propellant.

16. A dispenser as claimed in claim 15, wherein said solvent is ethanol.

17. A valve for use in a dispenser for dispensing a medicament in a fluid propellant, the valve made wholly or substantially of metal, wherein the internal metal surfaces of said valve comprise a coating which enhances the surface energy thereof.

18. A valve as claimed in claim 17, wherein the valve is a metering valve.

19. A metered dose inhaler comprising a dispenser according to any one of claims 1 to 16 and a medicament-channeling device.

20. A method of preventing drug deposition in a dispenser for dispensing a medicament in a fluid propellant having a canister for housing the medicament and a drug-dispensing valve, the method comprising the use of a dispenser or a drug metering valve as claimed in an one of claims 1 to 19.

21. A method as claimed in claim 20, wherein the valve is a metering valve.
